(19) United States
(12) Patent Application Publication
(10) Pub. No.: US 2006/0002471 A1
(43) Pub. Date: Jan. 5, 2006

(54) Motion estimation unit

(76) Inventors: Louis A. Lippincott, Los Altos, CA (US); Kalpesh Mehta, Chandler, AZ (US); Shashikiran H. Tadas, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,457

(22) Filed: Jun. 30, 2004

(51) Int. Cl. H04B 1/66; H04N 11/02; H04N 11/04; H04N 7/12

(52) U.S. Cl. 375/240.16; 375/240.24; 375/240.12

(57) ABSTRACT

Embodiments include a motion estimation unit having a sum of absolute differences (SAD) engine for calculating differences between a reference block of current image pixel data and search windows of prior image pixel data. The reference block is stored in the SAD engine and columns of search window pixel data are consecutively loaded in the SAD engine with each clock cycle, so that SAD values and corresponding motion vectors can be sent to a threshold unit for comparison with threshold values for the reference block or portions thereof, every clock cycle. The threshold unit halts processing if a threshold value is satisfied and outputs the best SAD values and corresponding motion vectors to downstream processing. Also, a memory may store SAD values and corresponding motion vectors from the SAD engine, so that those values and vectors can be combined for multiple reference blocks as compared to the same search window.

### BACKGROUND

1. Field

Digital image data motion estimation and prediction.

2. Background

Video data motion estimation and prediction is used in video or image processing, encoding, and/or display. For example, predicting the motion of objects in images included in an input stream of video may provide better overall quality display, such as by providing a display of video and/or images that is smooth and appealing to a viewer. Specifically, the motion of objects, which are present in a current frame of image or video data, can be computed based on the previous frame, in a sequence of frames of the data by a motion estimation unit (MEU). An MEU may be used to estimate the motion in video data formatted in Moving Picture Experts Group (MPEG) (e.g., such as MPEG2 or MPEG4).

### BRIEF DESCRIPTION OF THE DRAWINGS

Various features, aspects and advantages will become more thoroughly apparent from the following detailed description, the claims, and accompanying drawings in which:

FIG. 1 is a block diagram of an apparatus for performing sum of absolute differences (SAD) value calculations between a current image and a previous image.

FIG. 2 is a block diagram of an apparatus for performing SAD calculations.

FIG. 3 shows a block of pixel data for a previous image.

FIG. 4 is a block diagram of a portion of an apparatus for identifying a best SAD value and performing a threshold determination.

FIG. 5 is a flow diagram of a process for motion estimation.

FIG. 6 is a flow diagram of a process for motion estimation of a reference block having a size greater than an 8×8 pixel block.

FIG. 7 is a block diagram of a signal processor showing eight processing elements (PEs) intercoupled to each other via cluster communication registers (CCRs), according to one embodiment of the invention.

FIG. 8 is a block diagram of a memory command handler (MCH) coupled between a memory and the CCRs for retrieving data from the memory for use by the PEs, according to one embodiment of the invention.

### DETAILED DESCRIPTION

Motion Estimation is a process of predicting the motion of objects. In this process, the motion of objects, which are present in a current frame or image of a stream of video data, is computed based on the previous frame, in a sequence of frames of the data. Specifically, according to embodiments, a motion estimation (ME) unit or “MEU” may produce motion vectors based on comparisons of reference blocks and search window areas of images from a sequence of presumably temporally and spatially related images or material, such as a stream of video data having frames of pixel or image data. Note that the ME unit need not necessarily provide true motion vectors, but may instead provide the locations of the best matches of a reference block against an image in a particular search window. It is entirely possible that the true motion carried an object partially or fully out of the search range. Even so, the ME unit may still give an answer that represents the best match, based on a sum of the absolute differences for example, within the search window. As an alternative, the best match may be determined by computing a sum of squared differences (SSD) or other appropriate comparison or difference for each pair of current and previous blocks.

It can be appreciated that the apparatus, systems, and processes describe herein may also be applied to compare or determine a difference between a reference block of data of a previous image and search window data of a current image. Furthermore, the apparatus, systems, and processes describe herein may be applied to compare or determine a difference between a reference block and a search window of data of any two frames of a stream of video data, such as a stream of data having a sequence of frames of pixel data being transmitted, received, or having the capability to be displayed such that the frames appear to be in constant motion.

For example, a sum of absolute differences (SAD) may be a function applied by or during a ME unit or a ME process or calculation, which indicates the difference between a block of data in the current frame to another block in the previous frame. The lower the SAD, the better the match and thus better the overall quality of the motion estimation, image processing, encoding, and/or display. A SAD value may be calculated as:
SAD(x,y)=_{I}ΣⱼΣ|C(I,j)−P(x+I,y+j)|, a)

where “C(I,j)” stands for current frame, “P(x, y)” stands for previous frame, “i” and “j” define the search window region (e.g., such as for either a 4×4 pixel block, or an 8×8 pixel block).

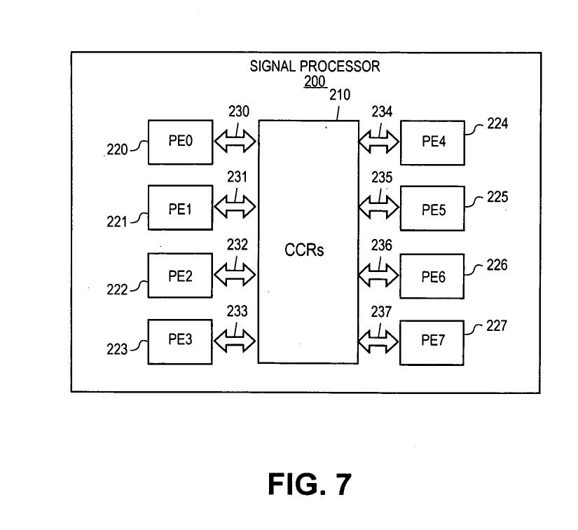

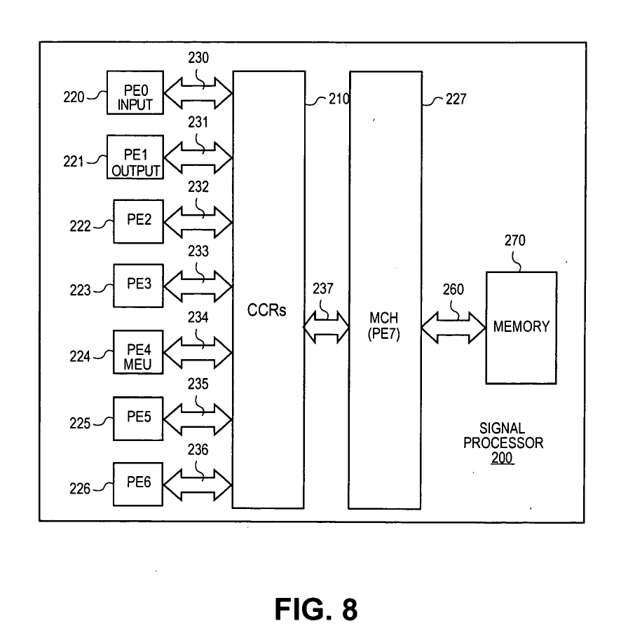

In accordance with embodiments, a MEU (e.g., such as PE4 224 and/or PE6 226 as described below with respect to FIGS. 7 and 8) may use a systolic architecture that reuses the pixel data, thus reducing the memory bandwidth required to perform SAD computation. For instance, a MEU may use a memory structure to hold search window data temporarily (e.g., such as by temporarily storing a total search region having a number of search windows from the previous frame of image data) before feeding the search windows to a SAD engine to calculate SAD values for the search window as compared to a reference block of data (from the current frame if image data) stored in a register file inside the SAD engine.

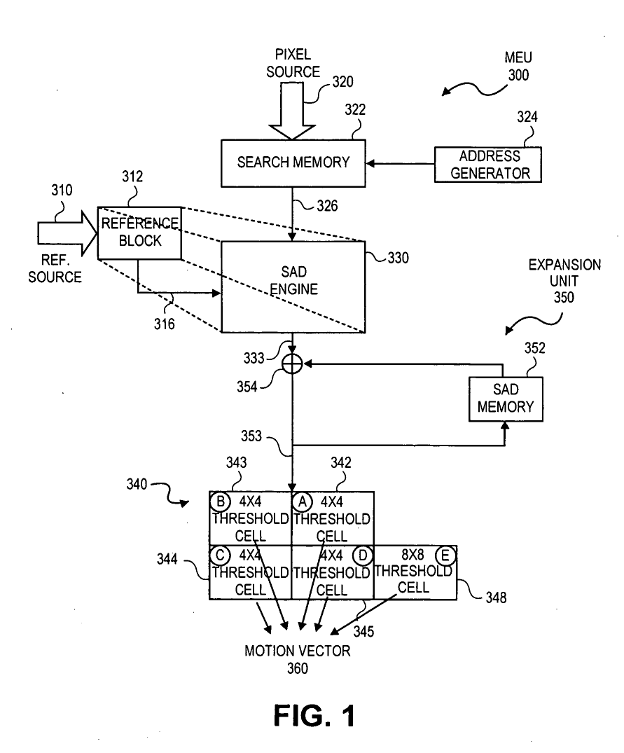

For example, FIG. 1 is a block diagram of an apparatus for performing sum of absolute differences (SAD) value calculations between a current image and a previous image. FIG. 1 shows motion estimation unit (MEU) 300 having search memory 322 connected to SAD engine 330, which is coupled to threshold unit 340 via a path that optionally uses expansion unit 350 (e.g., such as where expansion unit 350 includes SAD memory 352 and adder 354).

Pixel source 320 is for providing a source of pixel input data of a previous image to search memory 322, which may store a total search region and may send portions of the total search region to SAD engine 330 via data path 326 to form search windows (e.g., such as by providing portions thereof). Moreover, search memory 322 may provide write address to store or write a total search region of data into search memory 322 from pixel source 320, and may also provide a read address to retrieve or read a search window from search memory 322 to SAD engine 330. Specifically, search memory 322 may provide portions (e.g., such as columns) of one or more search windows of data from a total search region of a previous image to SAD engine 330, such as according to instructions, addresses, data, or information received by search memory 322 from address generator 324. Thus, search memory 322 may be configured or described as a search region memory to store a total search region of data, pixels, pixel blocks of previous image including a number of search windows of data and portions thereof. It is contemplated that search memory 322 may be a random access memory (RAM) (e.g., such as an 8 kilobyte (KB) RAM memory), a static RAM (SRAM), a dynamic RAM (DRAM), an MCH memory, a programmable memory, a local memory, a cache memory, or another appropriate memory to temporary release store data, pixels, or pixel block.

Similarly, reference source 310 is for providing a source of reference input data of a current image, such as reference block 312, to SAD engine 330 via data path 316. More particularly, reference source 310 may provide a write address to store or write a reference block of data into SAD engine 330.

According to embodiments, reference source 310, such as including a current image, and pixel source 320, such as including a previous image, may be part of a digital data stream of pixels, video, source input, and/or image data. For example, the digital data stream may include frames of data pixels, and/or images, such as a current frame or image and previous frame or image, from video data of related images, frames, data, pixels, etc.

It is also considered that pixel source 320 may be or may be provided by a one or more registers, cluster communication registers (CCRs), general purpose registers (GPRs), data paths, or couplings (e.g., such as described herein with respect to couplings 230 through 237 and 260 of FIGS. 7 and 8). Similarly, reference source 310 may be one or more components as described above with respect to pixel source 320. Notably, reference source 310 and pixel source 320 may represent a plurality of GPR's, or CCR's, such as described herein with respect to FIGS. 7 and 8, coupled to a reference storage device (e.g., such as a set of registers) within SAD engine 330 and coupled to search memory 322, where the GPR's or CCR's are shared by and mapped to an addressing space of a number of PE's, such as described above with respect to FIGS. 7 and 8.

SAD engine 330 may access or obtain search windows of image pixel data from search memory 322 and a reference block of image pixel data from the reference storage device within SAD engine 330 to determine SAD values between the reference block of data from the current image and the plurality of search windows of data from the previous image. Moreover, each search window may include a first part or portion of a previous search window already compared (e.g., such as previously compared with respect to time) with the reference block by the SAD engine, and another part or portion of a subsequent different search window adjacent to the previous search window. For example, reference block 312 and search memory 322 may include a number of pixels of video or image data, such as from a data stream as described herein. Thus SAD engine 330 may be a comparison, difference, SAD, or SSD engine, array, unit, comparison unit, processor, signal processor, digital signal processor, or other computing entity as described herein that compares one or more pixels of reference block 312 with one or more pixels of search memory 322. Specifically, SAD engine 330 may calculate a SAD value equal to a sum of absolute values which are the value of a pixel of the reference block less a value of a pixel of the search window (e.g., such as described by equation “a” above).

In addition, search memory 322 may provide data to temporary registers within SAD engine 330. Similarly, reference block 312 may be stored in a reference storage device within SAD engine 330. More particularly, SAD engine 330 may calculate, be configured to calculate, and/or be programmed to calculate a SAD value for various sized pixel blocks. Specifically, SAD engine 330 may calculate a SAD value for an 8×8 and/or 4×4 pixel block within reference block 312 as compared to the search window temporary registers.

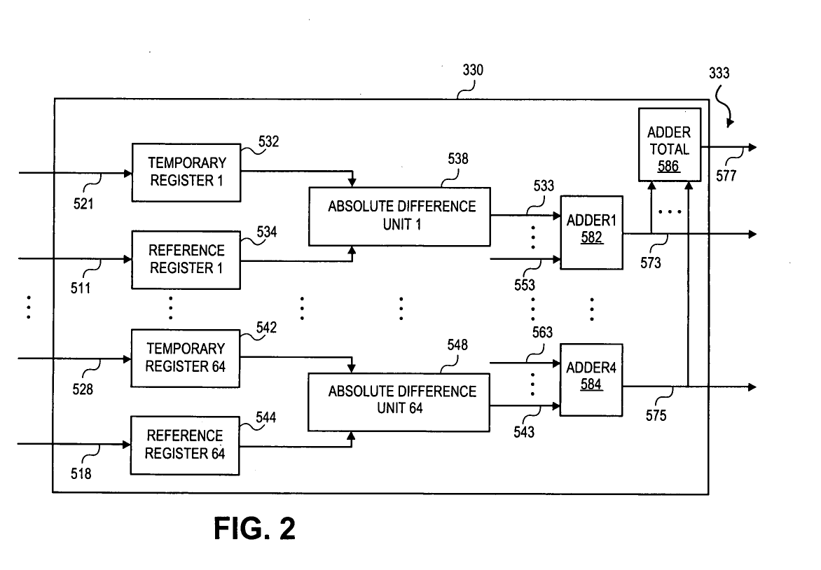

For instance, FIG. 2 is a block diagram of an apparatus for performing SAD calculations. FIG. 2 shows SAD engine 330 (e.g., such as a SAD unit, array or engine) for calculating SAD values for an 8×8 array of pixel or pixel block reference block as compared to search window. FIG. 2 shows SAD engine 330 including a number of register pair, absolute difference unit combinations where each register pair absolute difference unit combination is to calculate the absolute difference of one pixel data of the reference block as compared to one pixel data of the search window.

For example, temporary register 1-532 may receive pixels from search memory 322 via data path 521, such as where data path 521 may be part of data path 326. Thus, temporary register herein, such as temporary register 1-532, may be considered or described as search memory to store search window data, pixels, pixel blocks, and portions thereof from a previous image. In addition, search memory 322 may be described as a search memory as well.

Likewise, reference register 1-534 may be a part of a reference storage device as described above, such as to store a pixel of data of reference block 312 (e.g., part of reference block 312 stored in SAD engine 330). Reference registers, such as reference register 1-534 may be considered or described as reference storage device to store reference block data, pixels, pixel block, and portions thereof from a current image. Thus, reference register 1-534 may receive a pixel of reference block data via data path 511, such as where data path 511 may be part of data path 316. Absolute difference unit 1-538 receives the search window data stored in temporary register 1-532 and the reference block data stored in reference register 1-534 and produces an absolute difference between the data, such as by producing an absolute difference value for the value of the pixel of search window data as compared to the pixel of reference block data. The absolute difference calculated may then be output via data path 533.

SAD engine 330 may include 64 pairs of registers coupled to absolute difference units, such as to process an 8×8 pixel block reference block of data as compared to an 8×8 search window. Thus, SAD engine 330 may include register pairs and absolute difference units 1 through 64. Specifically, FIG. 2 shows temporary register 64-542 and data path 528 having a structure and/or functionality similar to temporary register 1-532 and data path 521, as described above. Similarly, reference register 64-544 and data path 518 may have a structure and/or functionality similar to that described above with respect to reference register 1-534 and data path 511. Next, absolute difference unit 64-548 and data path 543 may have a structure and/or functionality similar to that described above with respect to absolute difference unit 1-538 and data path 533. In addition, according to embodiments, data paths 533 to 543 may be coupled to one or more adders or vector generating devices or structures such as adders, devices, and/or structures within SAD engine 330, to produce a SAD for all, a group of, or any of the register pair, absolute difference unit combinations (e.g., such as to produce SAD values and/or motion vectors as described with respect to data path 333, 353, and outputs of SAD engine 330).

Specifically, as shown in FIG. 2, data path 533 may be combined with sixteen other similar data paths (e.g., such as represented by data path 533 through 553 as shown in FIG. 2) at adder 1-582 to provide output 573 which is the SAD value for the first 4×4 pixel block of an 8×8 pixel block reference block as compared to an 8×8 pixel block search window. Similar structures may be used to add the SAD values for the other three 4×4 pixel blocks of the 8×8 pixel block reference block as compared to the 8×8 search window. For example, as shown in FIG. 2, data path 563 through 543 may represent the last sixteen SAD values corresponding to the last 4×4 pixel block of an 8×8 pixel block reference block as compared to an 8×8 search window (e.g., such as by being the last sixteen data paths from absolute different unit 1-538 through absolute different unit 64-548). Thus, adder 4-584 may combine the SAD values for the last 4×4 pixel block and provide the output as output 575. In addition, the output of each of the 4×4 pixel block adders (e.g., such as the output of adder 1-582 through adder 4-584, as shown in FIG. 2) may also be combined to provide the total SAD value for the 8×8 pixel block reference block as compared to the 8×8 search window. Specifically, as shown in FIG. 2, adder total 586 may combine the SAD values for output 573 through 575 (e.g., such as by combining the SAD value outputs for four 4×4 pixel blocks SAD values of an 8×8 pixel block reference block as compared to an 8×8 search window) and may provide the output as total output 577. It is to be appreciated that total output 577 and outputs 573 through 575 may be equal to or part of data path 333.

It may be appreciated that the structure shown in FIG. 2 and described below may apply to smaller or larger arrays or pixel blocks. Similarly, the structure of FIG. 2 or a larger structure may be used to calculate SAD values for a number of pixels less than the number of absolute difference units shown.

SAD engine 330 may also produce a motion vector or vectors providing the location of the best match of a reference block against an image in a particular search window. For example, SAD engine 330 may produce, identify, or generate a motion vector corresponding to any SAD value as described above, such as a motion vector corresponding to a 4×4 pixel block SAD value, and 8×8 pixel block SAD value, a 8×16 pixel block SAD value, a 16×8 pixel block SAD value, a 16×16 pixel block SAD value . . . etc., as mentioned herein. Specifically, the motion vector may be a vector equal to a best matched based on the SAD value subtraction, comparison, or difference between a location of a reference block in a current image as compared to a location of a corresponding block of search data (e.g., such as a block of search data for which the SAD values or values have been calculated by SAD engine 330) of a total search region (e.g., such as search region 420 of FIG. 2) of a previous image. Note that it is contemplated that the location of the corresponding block of search data may or may not be entirely within the total search region, and thus the vector may be referred to as a pseudo-motion displacement vector.

According to one embodiment, SAD engine 330 may calculate a motion vector as described above for each of four different 4×4 pixel blocks within a reference block as compared to a or each search window, as well as one 8×8 pixel block within the reference block as compared to a or each search window of data. In one instance, SAD engine 330 may implement an 8×8 pixel block SAD, and optionally four 4×4 pixel block SAD's within the 8×8 pixel block SAD, using a pipelined implementation with throughput of 1 SAD calculation per clock cycle.

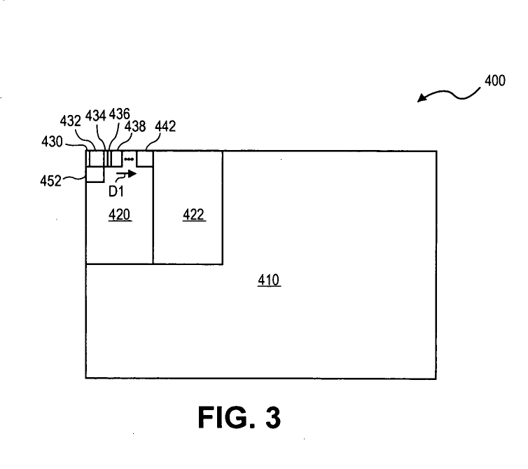

For instance, FIG. 3 shows a block of pixel data for a previous image. FIG. 3 shows block of pixel data 410 having total search region 420 and total search region 422. Total search region 420 includes search window portions 430, 432, 434, 436 and 438. For example, portions 430 through 436 may be combined to form complete search windows. Thus, a search window may be formed by portion 430 appended to, added to, combined with, and/or stored with portion 432. Similarly, portion 432 combined with or stored with portion 434 may form a second search window. Likewise, portions 434 through 438 may form a third search window. FIG. 3 also shows search window 442 and search window 452. According to embodiments, block of pixel data 410 may be various sized blocks, such as a 240×360 block of pixel data sampled from a 720×480 block pixel data image. It is also contemplated that block 410 may be a 720×480 pixel block of data or various other sized blocks of image or video data as known in the industry. Similarly, total search region 420 and 422 may be a 128×64 pixel block of data, or various other search region or search window sized block of data as known in the industry. Also, search windows formed by portions 430 through 438, search window 442, and/or search window 452 may be 4×4, 8×8, 8×16, 16×8, 16×16, 16×32, 32×16, 32×32, . . . , etc. pixel blocks of data. Specifically, for example, portion 430 may be a 1 wide by 8 deep column of pixel data, portion 432 may be a 7 wide by 8 deep pixel block, portions 434 and 436 may be 1 wide by 8 deep columns of pixel data, and portion 438 may be a 6 wide by 8 deep pixel block of image data. Moreover, MEU 300 may be programmed to retain, append and discard various numbers of columns and sized columns of pixel data to form search windows, such as by retaining a number of columns of pixel data of a prior search window previously compared to the reference block of data; and appending to that prior search window at lease one column of pixel data of a next different search window of the previous image that has not yet been compared to the reference block, and discarding at lease one column of pixel data of the prior search window that was previously compared to the reference block of data.

It can be noted that reference block 312 may have a size similar to that described above with respect to search windows for FIG. 2, such as search window 442, 452, or a search window formed by portion 430 and 432.

Address generator 324 may select or identify a total search region or portion thereof of data, pixels, or pixel blocks of a previous image to be stored in search memory 322. Address generator 324 may send a write address or addresses of search memory 322 identifying an address or addresses of search memory 322 to which a total search region or portion thereof is to be written (e.g., such as the address to temporary register 1-532 and temporary register 64-542). In one example, the write address would correspond to the addresses in search memory 322 to which total search region 420 is to be written.

Also, according to embodiments, address generator 324 may select or identify the search window or portion thereof to be compared with reference block 312. More particularly, generator 324 may generate a read address or addresses corresponding to an address or addresses in search memory 322, where the address or addresses correspond to or are the address of a portion of data, pixels, or pixel blocks of a previous image to be stored in temporary registers of SAD engine 330 (e.g., such as to be stored in temporary register 1-532 and temporary register 64-542 to form a search window). In fact, address generator 324 may select one or more of portions 430 through 438, such as by selecting portions 430 and 432 to form a first search window, and then appending portion 434 to portion 432 to form a second search window, as described above and as shown in FIG. 2. Thus, SAD engine 330 may calculate SAD values using search windows portions received, accessed, selected, identified, or read from search memory 322 according to address generator 324.

Specifically, for example, address generator 324 may generate a read address corresponding to a 1×8 column of data, such as portion 434 so that when search memory 322 receives that address it sends portion 434 to append portion 434 to portion 432 (e.g., such as where portion 432 is an “old” portion of data included in a search window for which SAD values have previously been calculated) to form a search window at the temporary registers of SAD engine 330, as described above with respect to FIG. 2. For instance, a new search window can be formed by appending portions 432 and 434 to form a search window there-including and excluding portion 430 by having search memory 322 retain portion 432 and shift portion 430 out of memory while appending or shifting portion 434 into temporary registers of SAD engine 330.

Moreover, SAD engine 330 may include one or more adders to add portions 430 to 438 of total search region 420, to form search windows by adding or combining data, pixels, or pixel block of a previous image, and/or as described above with respect to FIG. 3 (e.g., such as by adding portion 434 to portion 432 to form a search window to be stored in SAD engine 330 to be compared to reference block 312). Hence, referring to FIGS. 2 and 3, temporary registers 1-532 through 64-542 may store search windows of data from a previous image formed by adding portions 430, 432, 434, 436 and 438 as described above, where each search window includes a first portion of a first adjacent search window and a second portion of a second different adjacent search window (e.g., such as where the second search window is adjacent, superadjacent, next to, beside, above, below, corner to corner with, the fast search window). For example, a first search window may be portions 430 and 432 and a second difference adjacent search window may be portions 434, 436, and 438. Thus, temporary registers 1-532 through 64-542 may store a first search window having portions 430 and 432, than store a second search window having portions 432 and 434 (e.g., such as by shifting, deleting, removing, replacing, or otherwise removing portion 430 from search memory 322 and adding, writing, appending, or including portion 434 with portion 432, such as in an adjacent configuration shown in FIG. 2.

Once enough search window data is present and the reference data is stored in the SAD engine 330, a command can be provided to the SAD engine along with start and end addresses, to do the SAD computation(s). The start and end addresses could be the same in which case the SAD computation may be performed at single pixel position.

In this architecture, a column of 8-pixels may be sent from search memory 322 to temporary registers of SAD engine 330 every clock cycle. As such, the end of 8 cycles, the entire 8×8 search window data would reside or be stored in SAD engine 330. SAD engine 330 can then compute the SAD value and send the SAD value out to downstream stages (e.g., such as motion estimation of image processing or encoding post-processing, a motion estimation threshold stage, threshold unit 340, expansion unit 350, and/or memory SAD memory 352 as described below).

According to embodiments, during the next clock cycle, another column of 8-pixels may be sent to temporary registers of SAD engine 330 and the resulting SAD computation can be the value at the position offset by 1 in the x-direction. This processing may continue until the column of 8-pixels at the end of the row is sent and the SAD value including that row is calculated and processed. Moreover, SAD engine 330 may compute SAD values at both a 4×4 pixel block level as well as an 8×8 pixel block level. Thus, the SAD engine may produce one set of SAD value output(s) and motion vector(s) every clock cycle once the pipeline is full of columns of 8-pixels.

Moreover, MEU 300 may be programmed to handle various ME search widow selection algorithms such as a full search, a logarithmic search, a three-tier search, a diamond search, etc. For instance, it is contemplated that address generator 324 may be programmable, such as by including a memory to store a program, configuration registers to be configured, or other known programmable means, to select the portions or search windows of data from total search region 420 according to various programmable patterns and for motion estimation selection algorithms. For example, address generator 324 may select portions of search windows or search windows according to a full search pattern, a logarithmic search pattern, or a diamond search pattern, or other search pattern as known in the art. A full search pattern may include appending portions 430 through 438 as described above to form consecutive search windows moving in direction D1 as shown in FIG. 3 until reaching search window 442. After crossing search window 442, the address generator may cause search memory 322 to send search window 452 and progress in direction D1 similarly to the progression for the prior row as described above with respect to portions 430 through 438 and search window 442. Hence, portions used to form search windows such as portions 430 through 438 may be described as being adjacent, super-adjacent, consecutive, or related in location (e.g., such as by being consecutive in a full search or related in a logarithmic search, diamond search, or other search).

Referring to FIG. 1, downstream stages of MEU 300, from SAD engine 330, may include threshold unit 340. Specifically, as shown in FIG. 1, SAD engine 330 may send SAD value(s) and corresponding motion vector(s) to threshold unit 340 via data path 333 and 353. For example, in embodiments, the value of one or more SAD values or motion vectors provided by SAD engine 330 to data path 333 are equal to those received by threshold unit 340 via data path 353. Threshold unit 340 may have comparators compare SAD values and to determine a minimum SAD value for data, a pixel or a pixel block. The threshold unit may also compare the minimum SAD value against a user defined threshold value to cause early termination of SAD value calculations. To perform these functions, threshold unit 340 may have registers to hold the threshold value and a set of comparators to compare the computed SAD values against the threshold value.

Thus, after SAD engine 330 produces SAD value(s) and motion vector(s), threshold unit 340 may then receive the SAD value(s) and compare them against one or more corresponding threshold value(s). If a threshold value is met (e.g., such as by a SAD valued being less than, or less than or equal to the threshold valued), or the end of the search region is reached, then threshold unit 340 may send out the motion vector(s) and the corresponding SAD value(s). Specifically, threshold unit 340 may send out both 4×4 and 8×8 pixel block motion vectors and SAD values for an 8×8 pixel block reference block as compared to 8×8 pixel block search windows. In addition, once a threshold value is met, then threshold unit 340 may send out a termination or halt signal to cause early termination or halting of the motion vector search algorithm.

According to embodiments, threshold unit 340 may be a programmable architecture and/or post data processing unit to SAD engine 330 having at least one threshold memory block or threshold cell. Thus, threshold unit 340 may include one or more threshold cells for determining whether or not one or more SAD values satisfy, meet, are less than, are less than or equal to, or exceed a threshold value, such as a threshold value selected, entered, programmed, chosen, or input to the threshold unit from or by an apparatus, a PE, and/or a person or user. For example, FIG. 1 shows threshold unit 340 having 4×4 threshold cell A-342, 4×4 threshold cell B-343, 4×4 threshold cell C-344, 4×4 threshold cell D-345 and 8×8 threshold cell E-348.

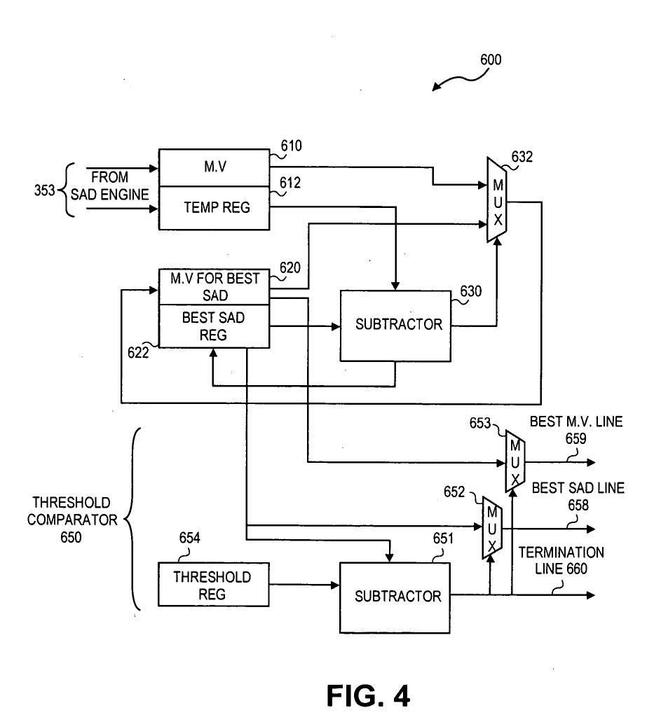

For example, FIG. 4 is a block diagram of a portion of an apparatus for identifying a best SAD value and performing a threshold determination. The apparatus of FIG. 4 may or represent a cell of threshold unit 340, such as threshold cell A-342, B-343, C-344, D-345 or threshold cell E-348. FIG. 4 shows a first set of registers having motion vector register 610 and temporary register 612 and a second set of registers having motion vector for best SAD value 620 and best SAD register 622. For example, temporary register 612 may be a register to store a SAD value calculated for a reference block and a search window (e.g., such as calculated for reference block 312 as compared to a search window from search memory 322 by SAD engine 330) received by the temporary register from a SAD unit, engine, or array (e.g., such as received from SAD engine 330 via data path 333 and/or data path 353). Similarly, motion vector 610 may be a temporary register to store a motion vector that corresponds to the SAD value stored in temporary register 612 (e.g., such as a motion vector output by SAD engine 330 as described above and received by register 610 via data path 333 and/or data path 353.

Correspondingly, register 622 may hold a SAD value that is the best SAD value determined for the cell so far or thus far according to calculations performed by the threshold cell. For instance, register 622 may contain, store, hold, or otherwise maintain temporarily or permanently a value of a best SAD value for the 4×4 pixel block, or 8×8 pixel block. Likewise, register 620 may hold the corresponding motion vector to the SAD value held at register 622, such as a motion vector corresponding to a SAD value as described above with respect SAD engine 330 of FIGS. 1-3.

Moreover, FIG. 4 shows multiplexor 632 and subtractor 630 coupled to outputs of registers 610, 612, 620, and/or 622, such as to compare a value stored in register 612 to a value stored in register 622 (e.g., such as to determine whether the SAD value stored in register 612 is less than the best SAD value stored in register 622). Furthermore, if the value in register 612 is a better SAD value than the value in register 622 (e.g., such as by the value in register 612 being less than the, less than or equal to, or otherwise better than the value in register 622) subtractor 630 and/or multiplexor 632 may replace the best SAD value stored in register 622 with the value stored in register 612. Similarly, if the value in register 612 is better than the value in register 622, multiplexor 632 and/or subtractor 630 may replace the motion vector for the best SAD value stored in register 620 with the motion vector stored in register 610 (e.g., such as to replace the motion vector corresponding to the best SAD value stored at register 620 with the motion vector corresponding to the newly determined best SAD value from register 612 that is now stored in register 622).

Specifically, subtractor 630 may be a subtractor or comparator to compare a progression or sequence of SAD values for a reference block as compared to a progression or sequence of search windows such as for a total search region (e.g., such as for 4×4 or 8×8 pixel blocks) with a best SAD value (e.g., such as a best SAD value determined thus far or the progression or sequence of search windows as compared to that specific reference block) by comparing the scalar SAD values received and temporarily stored at register 612 with whatever current best SAD value is stored at register 622 and updating the best SAD value at register 622 with any value temporarily stored at register 612 that is better, such as by being less than, the value stored at register 622.

Correspondingly, each time a SAD value stored at register 612 is determined to be better than the best SAD value stored at register 622, the motion vector stored at register 610 is also identified as, stored at, or used to replace the motion vector stored at register 620.

In addition, cell 600 may include threshold comparator 650, as shown in FIG. 4. Threshold comparator 650 includes threshold register 654, subtractor 651, and multiplexors 652 and 653, best motion vector line 659, best SAD line 658, and termination line 660. Threshold register 654 may store, maintain, or hold a selected threshold value such as a threshold value as described above with respect to threshold unit 340 and/or threshold cell 342 stored in a register such as described above with respect to register 612 through register 622. Specifically, threshold register 654 may store a user defined, or programmed SAD threshold value such as a value corresponding to a threshold value for a SAD value for 4×4 or 8×8 pixel blocks which when satisfied, met, exceeded, or when a SAD value is determined to be less than, or less than or equal to that threshold value for the pixel block, will cause the process of determining SAD values to terminate (e.g., such as by causing the processes described above with respect to SAD engine and threshold unit 340 to terminate).

For instance, an active signal transmitted on termination line 660 may cause a termination, halting, discontinuation, or otherwise stop SAD value calculations by SAD engine 330, address generation by address generator 324, search window determination by search memory 322, threshold value determination by threshold unit 340, and/or determinations described for cell 600 as described herein. Moreover, upon determining that a SAD value satisfies or is better than the threshold SAD value stored in register 654, the SAD value better than the threshold value and the motion vector corresponding to that SAD value may be stored and/or output, transmitted, or sent to downstream processing upon or after termination related to the active signal on termination line 660.

FIG. 4 shows subtractor 651 (e.g., such as the subtractor as described above with respect to subtractor 630) and multiplexors 652 and 653 and 653 (e.g., such as a multiplexor as described above with respect to multiplexor 632) for comparing a current SAD value and/or a best SAD value with a threshold value stored at threshold register 654. More particularly, when a best SAD value stored at register 622 satisfies, meets, is less than, and/or is less than or equal to the threshold value stored in register 654, subtractor 650 and/or multiplexors 652 and 653 may cause an active signal (e.g., such as a “high” signal, such as a logical “1”) to be transmitted via termination signal line 658 and/or may cause the best SAD value and the vector corresponding to the best SAD value to be transmitted on best SAD line 658 and best MV line 659 via multiplexors 652 and 653.

In one embodiment, a cell similar to cell 600 (e.g., such as a cell including threshold comparator 650) exists for each of threshold cells 342 through 348. Thus, after generation of each set of SAD values and corresponding motion vectors by SAD engine 330 for each search window compared to the reference block, a best SAD value and associated motion vector is determined for four 4×4 pixel blocks and an 8×8 pixel block, and the best SAD value is compared to the threshold value for each of the four 4×4 pixel blocks and the 8×8 pixel block.

It is contemplated that the processing described above with respect to threshold unit 340 and/or cell 600 may occur once per clock cycle. In other words, during a first clock cycle, SAD engine 330 may determine four 4×4 SAD values and/or an 8×8 SAD value and corresponding motion vectors for a reference block of a current image as compared to a search window of a previous image and transmit those values and vectors to threshold unit 340. Then, during a subsequent clock cycle, the SAD engine may determine another set of SAD values and vectors, while threshold unit compares the SAD values received to current best SAD values to make a best SAD value determination and determinates whether any of the SAD values and/or best SAD values is better than a threshold value.

Thus, threshold unit 340 and/or cells 600 may output a best SAD value and/or corresponding motion vector for each best SAD value for four 4>4 pixel blocks and an 8×8 pixel block prior to, upon, or after transmitting an active signal on one or more termination lines, similar to line 660, or upon completion of SAD value calculations for a total search region, such as search region 420. In other words, as shown in FIG. 1, motion vector 360 may be one or more motion vectors output from threshold cells either upon completion of SAD value calculations for a total search region. Thus, motion vector 360 may be motion vectors for four 4×4 and one 8×8 pixel blocks that are the best SAD value, such as stored at register 622, and the motion vector corresponding to the best SAD value, such as stored at register 620, for each of the pixel blocks. Also, motion vector 360 may be output from one or more motion vectors currently stored in the threshold cells upon one of the SAD values or best SAD values satisfying or being less than or equal to a threshold value for a pixel block, such as a threshold value stored in threshold register 654.

In addition, a MEU as described above, such as MEU 300, may be programmable to handle SAD computations at 4×4, 8×8 and also can be extended to handle reference block sizes greater than 8×8 pixel block SAD values (e.g., 8×16, 16×8, 16×16, etc.). For instance, embodiments of MEU 300 can include programmable logic circuits and registers to allow a user to change a pixel block size of a reference block of data and a plurality of search windows of data that the comparison unit is to ultimately compare. Thus, MEU 300 may have capability to send out SAD value computed at every pixel to the destination. In one case, this feature may be used to extend this architecture to support 16×16 pixel block SAD values. In this case, an 8×8 pixel block SAD values SAD computation may be done using the reference block from the left quadrant 8×8 reference block and the resulting SAD values every pixel is sent out to the destination, where it is stored temporarily.

For example, according to embodiments, as shown in FIG. 1, data path 333 may be an input to adder 354. According to this embodiment, data path 353 is coupled to SAD memory 352 which is an input to adder 354. It is contemplated that SAD memory 352 may be a memory or SAD “source” (e.g., such as a source of SAD data and vectors) sufficient to store one or more SAD values and motion vectors corresponding to the SAD values as described with respect to SAD engine 330 and threshold unit 340. It is also to be appreciated that adder 354 may be an adder sufficient to add, combine, append, or increase SAD values (e.g., such as SAD values and motion vectors received from SAD memory 352) previously calculated by SAD engine 330 with SAD values and vectors currently calculated by SAD engine 330, such as by adding SAD values and motion vectors at a pixel location calculated for one reference block of data as compared to a search window with a SAD value and motion vector calculated at the same pixel location for a different reference block of data as compared to the same search window.

Therefore, according to embodiments, expansion unit 350 of FIG. 1, including SAD memory 352 and adder 354, may be used to increase the capability of motion estimation unit 300 to greater than an 8×8 pixel block, such as by increasing it to an 8×16, 16×8, 16×16, 16×32, 32×16, 32×32, etc . . . pixel block capability. According to embodiments, expansion unit 350 may include SAD memory 352 to store a number of SAD values calculated by SAD engine 330 or one of a number of reference blocks of data from a current image as compared to a number of search windows for a total search region of a previous image. Specifically, SAD memory 352 may store SAD values for an 8×8 pixel block of data at reference block 312 as compared to a number of 8×8 search windows from search memory 322 for total search region 420. SAD memory 352 may be a memory as described herein with respect to memory 270 of FIG. 8. Also, SAD memory 352 may be a memory as described herein for search memory 322, may be an MCH memory, may be a local memory, and/or may be a programmable memory, such as programmable from a PE.

Thus, adder 354 may be used to add SAD values and/or motion vectors for a set of search windows of a total search region as compared to a first reference block of data (e.g., such as a reference block of data of a first 8×8 pixel block quadrant of a 16×16 total reference block) stored in SAD memory 352 to corresponding SAD values and motion vectors for the same set of search windows as compared to a second reference block of data (e.g., such as a second 8×8 pixel block reference block of data of a 16×16 total reference block) for the same total search region, such as by adding the SAD value and motion vector calculated at each pixel of the total search region for both of the reference blocks. Furthermore, the added SAD values and motion vectors output by adder 354 may be subsequently stored or replace the values previously stored in SAD memory 352 (e.g., such as by replacing the SAD values and motion vectors stored in SAD memory 352 for the first reference block with the SAD values and motion vectors added at adder 354 for the first and second reference block). Using this architecture or process it is possible to add together SAD values and motion vectors for subsequent reference blocks (e.g., such as four 8×8 reference blocks of a 16×16 total reference block of data, where the four 8×8 reference blocks represent the four quadrants of the 16×16 total reference block) to determine a set of total SAD values and/or total motion vectors for a total reference block of data greater than 8×8 (e.g., such as a 8×16, 16×8, 16×16, 32×32, etc. total reference block of data).

It is appreciated that the SAD values and motion vectors added by adder 354 for more than one reference block of data will have to take into consideration the locations of the reference blocks of data as compared to each other in the current image. For example, adder 354 may add SAD values for a second 8×8 pixel block reference block of data of a 16×16 total reference block as compared to a total search region to SAD values for a first 8×8 pixel block reference block of data of the 16×16 total reference block as compared to the same total search region, where the first reference block is a first 8×8 pixel block of a current image and the second reference block is the subsequent or next 8×8 reference block of data of the current image (e.g., such as where the first reference block is rows 0-7 and columns 0-7 of pixels of the current image and the second reference block is rows 0-7 and columns 8-15 of the pixel blocks of the current image). In this case, an appropriate offset of the first set of SAD values and motion vectors from SAD memory 352 as compared to the second set of SAD values and motion vectors generated by SAD engine 330 for the second reference block must be considered. An appropriate offset will cause adder 354 to add the first set and second set of SAD values and motion vectors that correspond to the appropriate pixel location within the total search region (e.g., such as by adding to the SAD value and motion vector calculated for each pixel of the first reference block stored in SAD memory 352 with the SAD value and motion vector calculated for a pixel 8 pixels to the right, or 8 columns over but in the same row, of the second reference block determined by SAD engine 330).

Moreover, once a total search region is completed, then the above process may be repeated, by using the 2^{nd} quadrant 8×8 reference block, but at the same time, the SAD values from the 1^{st} quadrant may be sent to adder 354 using SAD memory 352. At adder 354, the SAD value computed at every pixel for the second quadrant is then added with the SAD values from the corresponding pixel in the 1^{st} quadrant and sent out to SAD memory 352 where it is stored temporarily again. This procedure is repeated for a 3^{rd} and 4^{th} quadrant to get the entire 16×16 total reference blocks SAD value. This approach allows computation of SAD for blocks greater than 8×8 (16×8, 8×16, 16×16, etc) using external temporary storage (e.g., SAD memory 342 and/or a MCH as described for FIG. 8) using the MEU unit.

It is also contemplated that a SAD value compared to the threshold value of register 654 may be a SAD value received from a SAD value stored in a memory. Hence, for embodiments using expansion unit 350, threshold unit 340 may store a threshold value, such as a selected value as described above with respect to threshold register 654 for the total reference block (e.g., such as a total reference block having a size greater than an 8×8 pixel block, such as a total reference block of 8×16, 16×8, 16×16, 32×32, etc. pixel blocks). Thus, it is contemplated that threshold unit 340 may include a threshold value to compare to the total SAD value for each pixel generated by adder 354 up on completion of adding the values at each pixel for all of the reference blocks of data for the total reference block region (e.g., such as by comparing the total SAD value at each pixel of the total search region after the SAD values for each of the four 8×8 reference block quadrants of a total 16×16 reference block region has been added together at each of the pixels, as compared to the threshold value). In cases of SAD values for pixel blocks greater than 8×8 (e.g., such as 16×16 pixel block reference blocks), threshold unit 340 may simply compare SAD values received with the threshold value stored in register 654.

It is to be appreciated that SAD values and motion vectors for various other locations or quadrants of reference blocks of data as compared to the total search region may also be considered when adding SAD values and motion vectors for a third, fourth, etc . . . reference block of data to the SAD values and motion vectors of the first and second, first second and third, etc . . . reference block stored in SAD memory 352.

Thus, the various reference blocks of data to be compared to the total search region may be related, corner to corner, adjacent, super adjacent, or otherwise associated in location within the current image. More particularly, the SAD values and motion vectors for a third quadrant may be offset by considering pixels or loads of pixels that are down or below the first quadrant pixel by eight pixels or eight loads and are in the same first eight columns or in the same eight column as the first quadrant to form a third quadrant of a 8×8 pixel block reference block of data for a four 8×8 pixel block quadrant 16×16 total reference block of current image data.

More particularly, according to one embodiment, where the total reference block is a 16×16 pixel block separated into four 8×8 reference blocks having SAD values and motion vectors added by adder 354, threshold unit 340 (e.g., such as including a cell 600 having a threshold value stored in threshold register 654 for a 16×16 total reference block) may wait until SAD values and motion vectors for all four 8×8 reference blocks of data have been added together via adder 354 before determining whether the threshold value is satisfied. Thus, in this case, as the SAD values and motion vectors for the fourth quadrant 8×8 pixel block reference block of data are added to the first 3 quadrants of SAD values and motion vectors (e.g., such as by adder 354 adding the SAD values and motion vectors for quadrants 1, 2, and 3 added together and stored in SAD memory 352 to the SAD values and motion vectors being calculated by SAD engine 330 for the fourth 8×8 pixel block reference block of data stored at reference block 312) threshold unit 340 may determine whether the threshold value stored at threshold register 654 is met for each pixel of the total search region. In other words, during one clock cycle, SAD engine 330 may be determining SAD values and motion vectors for the fourth quadrant reference block of data, and during that or a subsequent clock cycle, adder 354 may be adding the SAD values and motion vectors for the fourth quadrant to those of the first three quadrants, and during that subsequent or another subsequent clock cycle threshold unit 340 may be determining whether the SAD value and/or threshold value for a pixel for all four quadrants of reference block data satisfy the threshold value at that pixel. Thus, if the SAD value of all four quadrants added together for a certain pixel location of the total search region satisfies or is less than the threshold value for the total 16×16 reference block, subtractor 650 and multiplexors 652 and 653 may output an active signal on termination length 660 and the best SAD value and best motion vector via lines 658 through 660, as described above with respect to FIG. 4. In this manner, if a total SAD value for the four quadrants satisfies the threshold value during SAD value computations for the fourth quadrant reference block, processing (e.g., such as SAD value calculations, and/or threshold calculations) may be terminated prior to completing processing of the entire four 8×8 pixel block reference block.

Also, according to embodiments, MEU 300 may exclude or not use expansion unit 350, such as by not including or using adder 354 or SAD memory 352, but instead having data path 353 equal to data path 333.

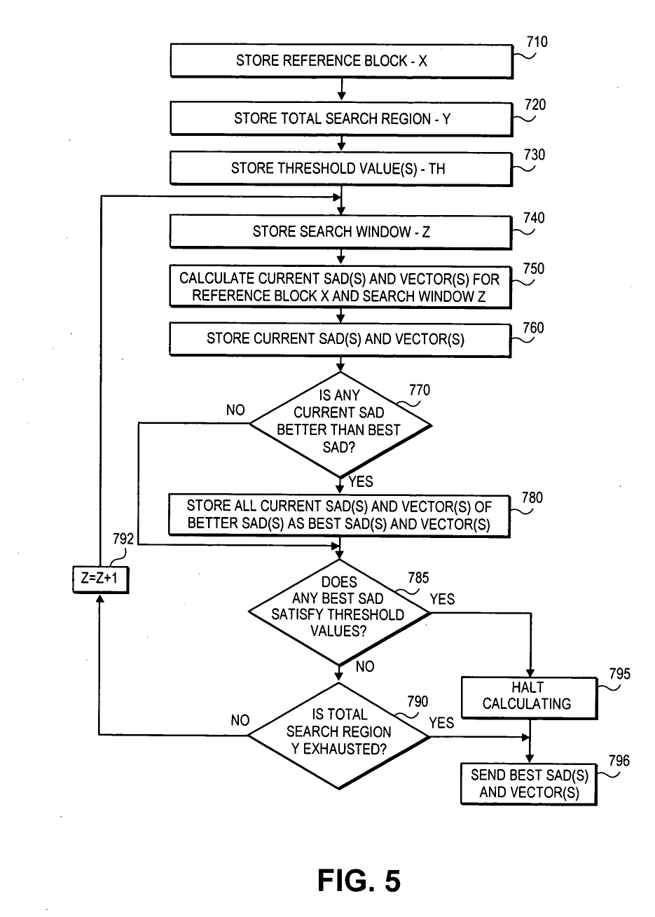

FIG. 5 is a flow diagram of a process for motion estimation. At block 710, reference block “X” is stored. Block 710 may correspond to storing a block of reference data of a current image such as described above with respect to reference block 312, SAD engine 330 and reference register 534 and “X” may correspond to one of a number of reference blocks of data for a total reference block, such as described above with respect to threshold unit 340, cell 600, and threshold register 654 (e.g., such as an 8×8 pixel block or quadrants of data).

At block 720, total search region “Y” is stored. Block 720 may correspond to storing a total search region of pixel data of a previous image such as described above with respect to pixel source 320 of FIG. 1 and/or total search region 420 of FIG. 3, and where “Y” may represent a sequence of total search regions such as described above with respect to total search regions 420 and 422 of pixel data 410 of FIG. 3.

At block 730, one or more threshold values “Th” are stored. Block 730 may correspond to storing threshold values such as described above with respect to threshold unit 340, cell 600, and/or threshold register 654.

According to embodiments, the process as described above with respect to block 710, 720, 730, and/or 740 may be performed in various orders. Specifically, according to one embodiment, the order of occurrence may be block 720, block 710, block 730, and then block 740.

At block 740, search window “Z” is stored. Block 740 may correspond to storing or generating a search window of data from a total search region as described above with respect to search memory 322, address generator 324, SAD engine 330, and/or temporary register 532. Specifically, at block 740, consecutive 1×8 pixel blocks or columns of pixel data may be sent to SAD engine 330 to create a consecutive search window for each consecutive block or column of data as described with respect to FIGS. 1-3 above.

At block 750, a current one or more SAD values (e.g., such as a set of SAD values for four 4×4 pixel blocks and an 8×8 pixel block and motion vectors corresponding thereto) may be calculated for reference block X as compared to search window Z. Block 750 may correspond to calculating one or more SAD values and determining one or more motion vectors corresponding to those SAD values as described above with respect to SAD engine 330, and data path 333.

At block 760, the current SAD values and motion vectors are stored. Block 760 may correspond to storing one or more SAD values and motion vectors as described above with respect to threshold unit 340, register 610, and register 612.

At decision block 770, it is determined whether any of the current SAD values are better than a best SAD value. For example, block 770 may represent comparing a SAD value to a best SAD value as described above with respect to threshold unit 340, cell 600, register 622, subtractor 630, and/or multiplexor 632. If at decision block 770 any current SAD value is not better than a best SAD value, the process continues on to decision block 785.

On the other hand, if at decision block 770 a current SAD value is better than a best SAD value, then the process proceeds to block 780. At block 780, any current SAD value(s) determined to be better than a best SAD value, and vectors corresponding to any current SAD values determined to be better than a best SAD value are stored, write over, or replace, the current best SAD value(s) and corresponding vector(s). Block 770 may correspond to storing a best SAD value and corresponding motion vector as described above with respect to threshold unit 340, cell 600, register 620, register 622, subtractor 630, and/or multiplexor 632.

At decision block 785 it is determined whether any best SAD value satisfies a threshold value. Block 785 may correspond to comparing a SAD value or a best SAD value as described above with respect to threshold unit 340, cell 600, threshold comparator 650, threshold register 654, subtractor 651, multiplexors 652 and 653, termination line 660, best SAD line 658, and/or best motion vector line 659. If at block 785 any best SAD value satisfies or is less than a corresponding threshold value, the process continues on to block 795.

At block 795 calculating is halted or terminated. Block 795 may correspond to the description above with respect to threshold unit 340, cell 600, threshold comparator 650, threshold register 654, subtractor 651, multiplexors 652 and 653, and termination line 660.

At block 796, the best SAD value or values and corresponding motion vector or vectors are sent or transmitted to downstream processing. Block 796 may correspond to the description above with respect to threshold unit 340, cell 600, threshold comparator 650, threshold register 654, subtractor 651, multiplexors 652 and 653, best motion vector line 659, and best SAD line 658.

If at block 785, no best value satisfies or is less than a corresponding threshold value, the process continues to decision block 790. At decision block 790 it is determined whether the total search region is exhausted, such as by determining whether all search windows of a total search region have been processed by the motion estimation unit. For example, block 790 may correspond to determining whether all search windows of total search region 420 have been processed as described above with respect to SAD engine 330, threshold unit 340, cell 600, threshold comparator 650, and/or expansion unit 350. If at block 790 the total search region has not been exhausted or processed then the process continues to block 792 where “Z” is incremented by 1. After block 792, the process continues back to block 740 where another search window is loaded and the process continues.

If at block 790 the total search region is exhausted, the process continues to block 796, where the best SAD value or values and corresponding motion vector or vectors are sent, as described above.

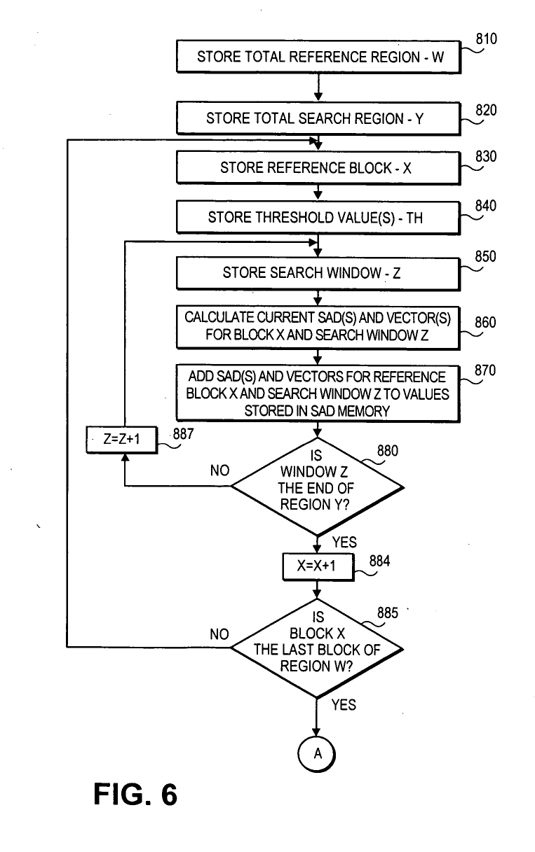

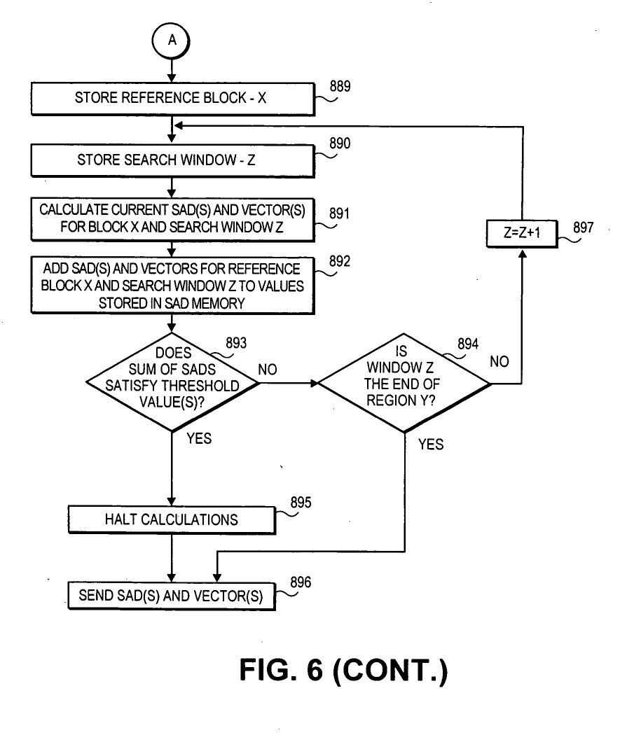

FIG. 6 is a flow diagram of a process for motion estimation of a reference block having a size greater than an 8×8 pixel block. At block 810, total reference region “W” is stored. Block 810 may correspond to storing a total reference region having a size greater than an 8×8 pixel block, such as a total reference region having a size of 8×16, 16×8, 16×16, 16×32, 32×16, 32×32, etc . . . from a current image, such as is described above with respect to reference source 310, reference block 312, exhaustion unit 350, SAD memory 352, adder 354, threshold comparator 650, and/or threshold register 654 as described above. For example, total reference region “W” may be a reference region including four or more 8×8 pixel blocks, such as having four 8×8 pixel block reference block quadrants.

At block 820, total search region “Y” is stored. Block 820 may correspond to the description above for block 720.

At block 830 reference block “X” is stored or loaded. Reference block X may be a total or a subdivision of total reference region W. For example, reference block X may be an 8×8 pixel block of data that is a portion or quadrant of total reference region W of a current image (e.g., such as where W is a 16×16 pixel block total reference block). In addition, block 830 may correspond to the description above with respect to block 710.

At block 840, one or more threshold values “Th” are stored. Block 840 may correspond to descriptions above with respect to block 730, threshold unit 340, cell 600, threshold register 654, threshold comparator 650, and/or extension unit 350. Specifically, block 840 may correspond to storing a threshold value for a block of pixel data having a size greater than an 8×8 pixel block, such as for a 16×16 pixel block.

It is contemplated that blocks 810, 820, 830, 840 and/or 850 may occur in various orders. For example, block 820 may occur before any of the other blocks and/or block 840 may occur before any of blocks 810 through 830. Similarly, the order of block 810 and block 820, or block 830 and block 840 may be reversed. In addition, block 830 may occur before block 820. Finally, block 850 may occur prior to block 840 or block 810, so long as block 850 occurs after block 820.

At block 850, search window “Z” is stored. Block 850 may correspond to the description above with respect to block 740.

At block 860, the SAD value or values and motion vectors for block X and search window Z are calculated. Block 860 may correspond to the description above with respect to block 750, SAD engine 330, expansion unit 350, adder 354, and/or SAD memory 352.

At block 870, the SAD values and motion vectors calculated at block 860 are added to SAD values and motion vectors currently stored in the SAD memory. Block 870 may correspond to the descriptions above with respect to expansion unit 350, SAD memory 352, adder 354, threshold comparator 650, subtractor 651, and/or threshold register 654. It may be appreciated that if the current SAD values and motion vector values stored in the SAD memory are zero, do not exist, or are for a previous total search region (e.g., such as being for total search region 420 while current SAD value calculations are being performed for total search region 422) then the SAD values and motion vectors calculated at block 860 may be replaced, or become the total value stored in the SAD memory. For example, the SAD values and motion vectors calculated at block 860 may replace any current zero or non-zero SAD values and motion vector values with the SAD values calculated at block 860, such as when the SAD values calculated at block 860 are for a first portion or quadrant of a total reference block.

At decision block 880, it is determined whether search window Z is the end of or exhausts total search region Y. Block 880 may correspond to the description above with respect to block 790. If at block 880 it is determined that total search region Y is not exhausted, processing continues to block 887 where “Z” is incremented by one. From block 887 processing continues to block 850 where the next search window is stored or loaded, and the process continues.

If at block 880, it is determined that total search region Y is exhausted, then the process continues to block 884 where “X” is incremented by one. After block 884, processing continues to block 885.

At block 885 it is determined whether reference block X is the last block of total reference region W, such as by determining whether the total reference region has been exhausted so that the current block X is the last reference block of region W. Block 885 may correspond to the description above with respect to calculating SAD values and motion vectors for multiple reference blocks, such as described with respect to expansion unit 350, SAD memory 352, adder 354, threshold unit 340, threshold comparator 650, and/or threshold register 654.

If at block 885 it is determined that reference block X is not the end of total reference region W, then processing continues to block 830 where a subsequent, next, additional, associated, or other reference block of total reference region W is stored or loaded for consideration and the process continues. For example, loading a subsequent or next reference block X of total reference region W may correspond to descriptions above with respect to expansion unit 350, SAD memory 352, adder 354, reference source 310, reference block 312, threshold unit 340, threshold comparator 650 and/or threshold register 654.

If at block 885 it is determined that reference block X is the last block of the total search region, then the process continues to block 889. At block 889, the last reference block “X” for region W is stored or loaded. Block 889 may correspond to the description above for block 830 and block 885. For example, at block 889, a subsequent or additional reference block of total reference region W may be stored or loaded, where that block is the last or final reference block of total reference region W, thus completing the consideration of total reference region W as compared to the total search region Y. After block 889, processing continues to block 890.

At block 890, search window “Z” is stored. Block 890 may correspond to the description above with respect to block 850. At block 891, the SAD value or values and motion vector or vectors for block X and search windows Z are calculated. Block 891 may correspond to the description above with respect to block 860.

At block 892, the SAD values and motion vectors calculated at block 891 are added to SAD values and motion vectors currently stored in the SAD memory. Block 892 may correspond to the description above with respect to block 870. It is noted that since the current block X is the last block of region W, the SAD value and motion vector sums at block 892 may be the total SAD values and total motion vectors for the total reference region W as compared to total search region Y (e.g., such as where block 892 provides a pixel by pixel total SAD value and motion vector for each pixel of total search region Y as compared to total reference region W).

At decision block 893 it is determined whether one or more SAD values summed at block 892 (e.g., such as the sum of SAD values calculated at block 891 and appropriate corresponding SAD values currently stored in the SAD memory as described above with respect to expansion unit 350 of FIG. 1 and block 870) satisfies one or more corresponding threshold values. Block 890 may correspond to the descriptions above with respect to threshold unit 340, cell 600, threshold comparator 650, threshold register 654, and/or subtractor 651. Specifically, for instance, a selected threshold value for total reference region W, or a portion thereof may be compared to the total SAD value summed at block 892 for the total reference region W, or a portion thereof, for each pixel location of total search region Y, as described above with respect to threshold comparator 650 and/or threshold register 654. If at decision block 893 the SAD value or values summed at block 892 do not satisfy (e.g., such as by being greater than) a corresponding threshold value, the process continues to block 894.

On the other hand, if at block 893 one or more SAD values summed at block 892 do satisfy (e.g., such as by being less than, or less than or equal to) a threshold value, then the process continues to block 895. At block 895, calculations or processing is halted block 895 may correspond to descriptions above with respect to block 795, threshold unit 340, cell 600, threshold comparator 650, termination line 660, and/or extension unit 350 (e.g., such as description thereof and appropriate for motion estimation of a reference block having a size greater than an 8×8 pixel block). After block 895, the process continues to block 896.

At decision block 894, it is determined whether search window Z is the end of or exhausts total search region Y. Block 894 may correspond to the description above with respect to block 880. If at block 894 it is determined that total search region Y is not exhausted, processing continues to block 897 where “Z” is incremented by 1. From block 897, processing continues to block 890 where the next search window is stored or loaded, and the process continues.

If at block 894 it is determined that total search region Y is exhausted, processing continues to block 896.

At block 896, the current best SAD value or values for the total reference block and corresponding motion vector or vectors are sent or transmitted to downstream processing. Block 896 may correspond to the description above with respect to block 796, threshold unit 340, cell 600, threshold comparator 650, best motion vector line 659, best SAD line 658, and/or expansion unit 350.

It is contemplated that a ME unit as described herein (e.g., such as MEU 300) may be part of a larger and/or more complex image signal processor or processing element. For instance, FIG. 7 is a block diagram of an image signal processor (ISP) (e.g., such as a digital signal processor for processing video and/or image data) having eight processing elements (PEs) intercoupled to each other via cluster communication registers (CCRs), according to one embodiment of the invention. As shown in FIG. 7, signal processor 200 includes eight programmable processing elements (PEs) coupled to cluster communication registers (CCRs) 210. CCRS 210 may be or include one or more GPRs as described above. Specifically, PE0 220 is coupled to CCRs 210 via PE CCR coupling 230, PE1 221 is similarly coupled via PE CCRs 231, PE2 222 via coupling 232, PE3 223 via coupling via 233, PE4 224 via coupling 234, PE5 225 via coupling 235, PE6 226 via coupling 236, and PE7 227 is coupled to CCRs 210 via coupling 237. According to embodiments, CCRs for coupling each PE to every other PE, may have various electronic circuitry and components to store data (e.g., such as to function as a communication storage unit, a communication register, a memory command register, a command input register, or a data output register as described herein). Such electronic circuitry and components may include registers having a plurality of bit locations, control logic, logic gates, multiplexers, switches, and other circuitry for routing and storing data.

Moreover, signal processor 200 may be coupled to one or more similar signal processors, where each signal processor may also be coupled to one or more memory and/or other signal processors (e.g., such as in a “cluster”). Also, each cluster may be coupled to one/or more other clusters. For instance signal processor 200 may be connected together in a cluster of eight or nine digital signal processors in a mesh configuration using Quad-ports. The quad-ports can be configured (statically) to connect various ISP's to other ISP's or to double data rate (DDR) random access memory (RAM), such as a “main memory” using direct memory access (DMA) channels. For example, signal processor 200 may be or may be part of programmable multi-instruction multiple data stream (MIMD) digital image processing device. More particularly, signal processor 200, whether coupled or not coupled to another signal processor, can be used for image processing related to a copier, a scanner, a printer, or other image processing device including to process a raster image, a Moving Picture Experts Group (MPEG) image, or other digital image data.

In addition, signal processor 200 can use several PE's connected together through CCRs 210 (e.g., such as where CCRs 210 is a register file switch) to provide a fast and efficient interconnection mechanism and to maximize performance for data-driven applications by mapping individual threads to PE's in such a way as to minimize communication overhead. Moreover, a programming model of the ISP's can be implemented is such that each PE implements a part of a data processing algorithm and data flows from one PE to another and from one ISP to another until the data is completely processed.

Moreover, in embodiments, a PE may be one of various types of processing elements, digital signal processors, comparison units, video and/or image signal processors for processing digital data. Similarly, a PE may be an input from one or more other ISP's, an output to one or more other ISP's, a hardware accelerator (HWA), a MEU (e.g., such as MEU 300), memory controller, and/or a memory command handler (MCH). For example, one of the PE's (e.g., PE0 220) may be an input from another ISP, one of the PE's (e.g., PE1 221) may be an output to other ISP, from one to three of the PEs (e.g., PE4, PE5 and PE6) may be configured as HWAs, at least one of the PEs (e.g., PE4) may be configured as a MEU (e.g., such as a HWA MEU, such as MEU 300), and one of the PEs (e.g., PE7 227) may be configured as a MCH functioning as a special HWA to manage the data flow for the other PE's in and out of a local memory. Thus, for example, an embodiment may include a cluster of PEs interconnected through CCRs 210, where CCRs 210 is a shared memory core of up to sixteen CCRs and each CCR is coupled to and mapped to the local address space of each PE.

FIG. 8 is a block diagram of a memory command handler (MCH) coupled between a memory and the CCRS, for retrieving and writing data from and to the memory for use by the PEs, according to one embodiment of the invention. As shown in FIG. 8, MCH 227 (e.g., PE7 configured and interfaced to function as a memory control handler, as described above with respect to FIG. 7) is coupled via MCH to CCR coupling 237 (e.g., coupling 237, as described above with respect to FIG. 7) to CCRs 210 which in turn are coupled to each of PE0 220 through PE6 226 via CCR PE0 coupling 230 through CCR PE6 coupling 236. In addition, MCH 227 is coupled to memory 270 via MCH memory coupling 260. Therefore, the PEs may read and write data to memory 270 via MCH 227 (e.g., such as by MCH 227 functioning as a central resource able to read data from and write data to CCRs 210).

According to embodiments, memory 270 may be a static RAM (SRAM) type memory, or memory 270 may be a type of memory other than SRAM. Memory 270 may be a local signal processor memory used for storing portions of images and/or for storing data temporarily, such as sum of absolute differences (SAD) values between pixels of a current data image and a prior data image. Specifically, memory 270 may provide the function of search memory 322, SAD memory 352, and/or block 870 as described above. Thus, memory 270 may SAD memory 352 by being an SRAM MCH memory, similar to a cache memory, used to temporarily store portions of images or complete image data that may originate from a DDR and may be staged in MCH 227.

Within signal processor 200, or a cluster of such signal processors (e.g., ISPs), Input PE and Output PE may be the gateways to the rest of the ISPs and can also be programmed to some level of processing. Other PEs within an ISP may also provide special processing capabilities. For instance, PE's acting as MEU's (e.g., such as MEU 300) of signal processor 200 (e.g. such as PE 4 and/or other PE's as shown in FIGS. 7 and 8) may perform video and image processing functions, such as motion estimation of objects in images of successive frames of video and/or image data, etc. For example, the apparatus, systems, and processes describe herein (e.g., such as the apparatus shown in FIGS. 7 and 8), may provide a programmable, memory efficient, and performance efficient way to estimate motion of objects in video and/or image data.

Thus, the design of the MEU may consider and/or place emphasis on throughput and area (gate count), such as to achieve the highest performance at the lowest possible gate count. In one case, a MEU as described above, may produce one Sum of Absolute Difference (SAD) every clock cycle. Moreover, as described above, such an MEU can be programmed to handle various ME search widow selection algorithm (e.g. Full search, Logarithmic search etc.). Also, as described above, such an MEU may be programmable to handle SAD computations at 4×4, 8×8 and also can be extended to handle reference block sizes greater than 8×8 (e.g., 8×16, 16×8, 16×16, etc.). For instance, embodiments described herein provide motion estimation capabilities that can be very useful for MPEG2 and MPEG4 encoding applications.

It is considered that the couplings, connections, lines, or data paths connecting devices, apparatus, systems, modules or components herein (e.g., such as those shown and described with respect to FIGS. 1-2, 4, and 7-8) may be sufficient electronic interfaces or couplings, such as various types of digital or analog electronic data paths, including a data bus, a link, a wire, a line, a printed circuit board trace, a wireless communication system, etc.

In the foregoing specification, specific embodiments are described. However, various modifications and changes may be made thereto without departing from the broader spirit and scope of embodiments as set forth in the claims. The specification and drawings are, accordingly, to be regarded in an illustrative rather than a restrictive sense.

What is claimed is:

1. An apparatus comprising:
a reference storage device to store a reference block of data from a first frame of a stream of video data;
a search memory to store a plurality of search windows of data from a second frame of the stream of video data, wherein each search window includes a first portion but not all of a first adjacent search window and a second portion but not all of a second different adjacent search window; and
a comparison unit to compare the reference block of data to the plurality of search windows of data.

2. The apparatus of claim 1, further comprising a plurality of programmable units to allow a user to change a pixel block size of a reference block of data and a plurality of search windows of data that the comparison unit is to compare.

3. The apparatus of claim 1, further comprising:
a search region memory to store a total search region of data of the second frames of the stream of video data, the total search region comprising the plurality of search windows; and
a programmable address generator to select one of (a) the total search region, and (b) the second portion from a plurality of locations in the total search region from a plurality of locations in the second frame of the stream of video data according to one of a full search pattern, a logarithmic pattern, and a diamond pattern.

4. The apparatus of claim 3, wherein the search region memory is a random access memory (RAM) to receive a source of pixel input data of the second frame of the stream of video data from a plurality of general purpose registers (GPR) according to the address generator, the search memory is a plurality of registers contained within the comparison unit to receive a portion of the pixel input data from the search region memory, and the reference storage device is a plurality of registers contained within the comparison unit to receive a source of reference input data of the first frame of the stream of video data from a plurality of general purpose registers (GPR).

5. The apparatus of claim 3, wherein the search memory is to store a seven column by eight row pixel block of data of a first search window from the total search region and the address generator is to select a one column by eight row pixel block of data of a second different search window stored in the total search region adjacent to the first search window to appended to the first portion.

6. The apparatus of claim 3, wherein the address generator is to generate a read address corresponding to an address in the search region memory to store a total search region, and a write address corresponding to an address in the search memory to which the second portion is to be read from by the comparison unit.

7. The apparatus of claim 1, wherein the comparison unit includes a sum of absolute differences (SAD) unit to calculate a plurality of first sum of absolute differences (SAD) values for the comparison of the plurality of search windows of data to the reference block of data.

8. The apparatus of claim 7, further comprising:
a SAD memory to store a first plurality of SAD values to be calculated by the comparison unit by comparing a first reference block of a plurality of reference blocks of data from the first frame of the stream of video data to a plurality of search windows of the total search region; and
an adder to add to the first plurality of SAD values, at least one related second plurality of SAD values to be calculated by the comparison unit by comparing at least one second different reference block of the plurality of reference blocks to a plurality of search windows of the total search region,
wherein a location in the first frame of the stream of video data of the at least one second different reference block is adjacent to a location in the first frame of the stream of video data of the first reference block.

9. The apparatus of claim 8, further comprising:
a plurality of processing elements each having an addressing space; a plurality of general purpose registers (GPR) coupled to the reference storage device and to the search region memory, wherein each of the plurality of GPRs is shared by and mapped to the addressing space of each processing element of the plurality of processing elements,
wherein the SAD memory is a local memory of a processing element configured as a memory command handler (MCH) to read and write data between the plurality of communication registers and the SAD memory, and the comparison unit is a processing element configured as a motion estimation unit.

10. The apparatus of claim 8, further comprising:
a threshold memory to store a selected threshold value;
a comparator to determine whether a first of the first plurality of SAD values added to a second of the at least one related second plurality of SAD values is less than or equal to the selected threshold value; and
a terminator to, if the first of the first plurality of SAD values added to the second of the at least one related second plurality of SAD values is less than or equal to the selected threshold value, halt determining a difference.

11. The apparatus of claim 7, further comprising:
a threshold unit having at least one threshold cell, wherein each threshold cell includes:
at least one first register to store a best SAD value for the plurality of SAD values and a motion vector corresponding to the best SAD value;
at least one second different register to store the plurality of SAD values and a plurality of motion vectors corresponding to the SAD values;
if a SAD value of the plurality is less than the best SAD value, a comparator to equate the best SAD value to the SAD value, and a multiplexer to equate the best motion vector to the motion vector corresponding to the SAD value.

12. The apparatus of claim 11, wherein each threshold cell further comprises:
at least one third register to store a selected threshold value;
a comparator to determine whether the best SAD value is less than or equal to the selected threshold value; and
a terminator to, if the best SAD value is less than or equal to the selected threshold value, halt determining a difference.

13. The apparatus of claim 11, wherein the reference storage device, the search memory, the search region memory, the comparison unit, and the threshold unit are part of a programmable pipeline implementation of a motion estimating unit.

14. A method comprising:
storing a reference block of data from a current image;
storing a first search window of data from a previous image,
calculating a difference between the reference block of data and the first search window of data;
storing a second different search window of data from the previous image, wherein the second different search window includes a portion of the first search window appended with a portion of the previous image adjacent in location in the previous image to the portion of the first search window; and
calculating a difference between the reference block of data and the second different search window of data.

15. The method of claim 14, wherein storing a second different search window comprises:
retaining a plurality of columns of pixel data of a prior search window previously compared to the reference block of data; and
appending at lease one column of pixel data of a next different search window of the previous image to the prior search window;
discarding at lease one column of pixel data of the prior search window.

16. The method of claim 14, wherein the portion of the previous image has not been compared to the reference block of data;
the method further comprising:
storing a total search region of the previous image;
reading the portion of the first search window from the total search region; and
reading the portion of the previous image from the total search region.

17. The method of claim 16, further comprising:
calculating a plurality of sum of absolute differences (SAD) values for the reference block of data as compared to a plurality of search windows for the total search region;
identifying a plurality of motion vectors corresponding to the SAD values;
determining a lowest SAD value for the plurality;
if the lowest SAD value is less than or equal to a threshold value, halting calculating and identifying; and
outputting the lowest SAD value and corresponding motion vector.

18. The method of claim 16, wherein reading the portion of the previous image from the total search region comprises selecting the portion of the previous image from a plurality of locations in the total search region according to one of a full search pattern, a logarithmic pattern, and a diamond pattern.

19. The method of claim 14, wherein calculating a difference comprises:
calculating a sum of absolute differences (SAD) value; and
identifying a motion vector corresponding to the SAD value.

20. The method of claim 19, wherein calculating a SAD value comprises:
calculating a plurality of SAD values for a plurality of portions of the reference block and a plurality of corresponding portions of the first search window or the second different search window;
calculating an overall SAD value for the plurality of SAD values.

21. The method of claim 19, wherein identifying the motion vector comprises:
calculating a motion vector for a lowest SAD value of a plurality of SAD values, the lowest SAD value corresponding to a current location of a reference block of pixel data in a current image of an image data stream as compared to a previous location of a search block of pixel data corresponding to the reference block of pixel data in a total search region in a previous image of the image data stream.

22. The method of claim 19, further comprising:
storing a best SAD value for the total search region and a best motion vector corresponding to the best SAD value;
determining whether the SAD value is less than the best SAD value; and
if the SAD value is less than the best SAD value, equating the best SAD value to the SAD value and equating the best motion vector to the motion vector corresponding to the SAD value.

23. The method of claim 22, further comprising:
storing at least one selected threshold SAD value;
determining whether at least one best SAD value is less than or equal to the at least one selected threshold SAD value; and
if at least one best SAD value is less than or equal to the at least one selected threshold SAD value, halting SAD value calculations.

24. The method of claim 21, further comprising:
calculating a first plurality of SAD values by comparing a first reference block of a plurality of reference blocks of data from a first frame of a stream of video data and a plurality of search windows of data of a second frame of data of the stream;
storing the first plurality of SAD values;
calculating at least one related second plurality of SAD values by comparing at least one different second reference block of the plurality of reference blocks to a plurality of search windows of the total search region,
wherein a location in the first frame of the at least one different second reference block is adjacent to a location in the first frame of the first reference block; and
forming a plurality of totally SAD values by adding the at least one related second plurality of SAD values to the first plurality of SAD values.

25. A system comprising:
a plurality of image signal processors (ISPs), each including a plurality of motion estimation units; and
a memory coupled to at least one of the plurality of ISPs,
wherein the motion estimation unit determines a plurality of sum of absolute difference (SAD) values between a reference block of data from a first frame of a stream of video data and a plurality of search windows of data from a different second frame of the stream of video data, wherein each search window includes a: first portion of a first adjacent search window and a second portion of a second different adjacent search window.

26. The system of claim 25, wherein the motion estimation unit includes a programmable systolic architecture to calculate the SAD values, and each SAD value is equal to a sum of at least one absolute value, wherein each at least one absolute value is the absolute value of a value of one pixel of the reference block of data less a value of a pixel of the first search window of data.

27. The system of claim 25, wherein the motion estimation unit is programmed to once per clock cycle (1) calculate a SAD for each of four 4×4 pixels blocks and an 8×8 pixel block within the search window as compared to the reference block, (2) calculate a motion vector for each of four 4×4 pixels blocks and an 8×8 pixel block within the search window as compared to the reference block, (3) calculate a best SAD for each of the four 4×4 pixels blocks and the 8×8 pixel block for a total search region, and (4) halt calculating a SAD and a best SAD if a best SAD satisfies a corresponding selected SAD threshold for all of the four 4×4 pixels blocks or for the 8×8 pixel block.

28. A machine-accessible medium containing instructions that, when executed, cause a machine to allow a user to:
program a motion estimation unit to select a plurality of reference blocks from a first frame of a stream of video data and a spatial relationship between the plurality of reference blocks of data, the spatial relationship of the reference blocks identifying a plurality of locations of the reference blocks within the first frame;
program the motion estimation unit to select a plurality of search windows for a second frame of the stream and a spatial relationship of the search windows, the spatial relationship of the search windows identifying a plurality of locations of the search windows within the second frame, wherein each search window includes a first portion but not all of a first adjacent search window and a second portion but not all of a second different adjacent search window;
the motion estimation unit to calculate a first plurality of comparison values between a first reference block of the plurality of reference blocks and the plurality of search windows;
the motion estimation unit to calculate at least one related second plurality of comparison values between a different second reference block of the plurality of reference blocks and the plurality of search windows; and
the motion estimation unit to combine the first plurality of comparison values with the second plurality of comparison values to form a plurality of total comparison values.

29. The machine-accessible medium of claim 28 further comprising instruction that, when executed, cause a machine to allow a user to:
program a threshold unit with a threshold value;
the threshold unit to determine whether a total comparison value satisfies the threshold value; and
if a total comparison value satisfies a threshold value, the motion estimation unit and the threshold unit to hold calculating comparison values, combining comparison values, and determining.

30. The machine-accessible medium of claim 28, wherein each of the first plurality of comparison values, the second plurality of comparison values, and the total comparison values includes a sum of all differences value and a motion vector; and wherein the threshold value includes a threshold sum of all differences value corresponding to the plurality of reference blocks.
